(19) United States
(12) Patent Application Publication
(10) Pub. No.: US 2010/0209557 A1
(43) Pub. Date: Aug. 19, 2010

(54) RECOVERY BLENDS FOR LIQUID BEVERAGES

(76) Inventors: DANIEL C. O'CONNOR, Shakopee, MN (US); TODD W. SMITH, Eden Prairie, MN (US)

Correspondence Address: O''Connor & Company, P.O. Box 580, Minnetrista, MN, 55364, US

(21) Appl. No.: 12/705,622

(22) Filed: Feb. 14, 2010

Related U.S. Application Data
(60) Provisional application No. 61/152,672, filed on Feb. 14, 2009.

(51) Int. Cl. A23L 2/52; A23L 2/38; A23L 1/28

(52) U.S. Cl. 426/66; 426/590; 426/655; 426/648

(57) ABSTRACT

The invention disclosed herein provides improved beverages, such as energy drinks and enhanced water, which can help the human body function better and recover faster from exercise or stress while maintaining a pleasant taste. Some embodiments of the invention describe recovery blends that include one or more ingredients selected from D-glucuronolactone, milk thistle extract, prickly pear extract, acai extract, and zeolites. Preferred beverage formulations do not include taurine. Some embodiments are designed specifically to be mixed with alcohol.

### PRIORITY DATA

This patent application claims priority under 35 U.S.C. §120 from U.S. Provisional Patent Application No. 61/152,672, filed Feb. 14, 2009, which is hereby incorporated by reference herein for all purposes.

### FIELD OF THE INVENTION

The present invention relates generally to the field of consumer beverages. The invention relates more specifically to compositions and methods for providing improved energy drinks for human consumption.

### BACKGROUND OF THE INVENTION

Functional beverages are currently growing in sales volume by double-digits annually in the United States, driven by so-called “energy drinks.” Energy drinks are soft drinks that provide more mental alertness and/or physical performance than a typical soft drink.

The demand for beverages that help to enhance the mental and physical wellness of drinkers has increased dramatically. Many different types of sport drinks, energy drinks, and enhanced waters have been marketed in recent years that claim to provide energy, endurance, and nutrients to the drinker.

However, there is still a need in the art for improved compositions that help the human body function better and/or recover faster from exercise or stress, while maintaining a pleasant taste for the consumer.

### SUMMARY OF THE INVENTION

The present invention addresses the aforementioned commercial needs in the art.

In some variations, the invention provides a liquid beverage comprising a recovery blend including zeolites. These zeolites can be natural zeolites, such as cellular zeolites, or synthetic zeolites.

The recovery blend can further include one, two, three, or four materials selected from the group consisting of D-glucuronolactone, milk thistle extract, prickly pear extract, and acai extract.

Liquid beverages of the invention preferably do not include taurine. In some embodiments, the beverage is a naturally sweetened energy drink. In some embodiments, the beverage is an artificially sweetened energy drink. In other embodiments, the beverage is a water drink.

In some specific embodiments, a liquid beverage (e.g., an energy drink) comprises a recovery blend including milk thistle extract and prickly pear extract. The recovery blend can further include zeolites.

Variations of this invention also provide novel recovery blends. In some embodiments, recovery blends comprise zeolites in effective amounts for enhancing mental and physical performance and endurance, in addition to accelerating recovery from stresses.

Recovery blends according to some embodiments comprise milk thistle extract and prickly pear extract. In certain embodiments, recovery blends additionally include (i) zeolites; (ii) acai extract; (iii) D-glucuronolactone; (iv) zeolites and acai extract; (v) zeolites and D-glucuronolactone; (vi) acai extract and D-glucuronolactone; or (vii) zeolites, acai extract, and D-glucuronolactone.

### DETAILED DESCRIPTION OF EMBODIMENTS OF THE INVENTION

The present invention will now be described in detail by reference to various non-limiting embodiments of the invention.

Unless otherwise indicated, all numbers expressing amounts, concentrations, and so forth used in the specification and claims are to be understood as being modified in all instances by the term “about.” Without limiting the application of the doctrine of equivalents to the scope of the claims, each numerical parameter should at least be construed in light of the number of significant digits and by applying ordinary rounding techniques.

As used in this specification and the appended claims, the singular forms “a,” “an,” and “the” include plural referents unless the context clearly indicates otherwise.

This invention is premised on the discovery that certain ingredients and combinations of ingredients can enhance recovery for persons after various types of physical, physiological, or neurological stress, while maintaining a pleasant taste.

In various embodiments of the invention, a “recovery blend” is provided which comprises one or more ingredients selected from the group consisting of D-glucuronolactone, milk thistle extract, prickly pear extract, acai extract, and zeolites. In some embodiments, two, three, four, or all five of these ingredients are included in the recovery blend. In certain embodiments, milk thistle extract and prickly pear extract are included, with or without acai extract and with or without zeolites. In some embodiments, the recovery blend includes zeolites.

A recovery blend can be introduced into any liquid or solid intended for human consumption. For example, without limitation of the invention, a recovery blend can be introduced into water, energy drinks, sports drinks, shakes, coffee, tea, juices, or alcohol. Beverages comprising the recovery blend can be carbonated or non-carbonated. Beverages or foods comprising the recovery blend can be naturally sweetened, artificially sweetened, or unsweetened.

It is noted that a recovery blend does not necessarily mean there is more than one ingredient in the blend; for example, some embodiments employ a recovery blend consisting essentially of zeolites, dissolved in purified water, to form an enhanced water beverage. Furthermore, reference to a “recovery blend” shall not limit the invention in any way to any particular method or order of steps for adding one or more ingredients within a blend. That is, part or all of a recovery blend can be added step-wise to a composition, and/or portions of a recovery blend can be present from a previous step or steps. In some embodiments of the invention, a recovery blend is provided as an intermediate or as a final product.

Examples of solids that can include a recovery blend are powders (which can be intended for mixing or dissolving into a liquid, or for direct consumption), gums, energy bars, cereals, and so on.

Preferred embodiments of the invention do not include any amount of taurine (2-aminoethanesulfonic acid, an organic acid).

One variation of the present invention provides a liquid composition comprising D-glucuronolactone, milk thistle extract, prickly pear extract, acai extract, zeolites, carbonated water (water with dissolved CO₂), sugar, citric acid, cellulose gum, sodium chloride, potassium phosphate, caffeine, ascorbic acid, potassium sorbate, niacin, calcium lactate gluconate, trimagnesium citrate, D-calcium panthothenate, pyridoxine, riboflavin, cyanocobalamin, and one or more natural or artificial flavors.

Another variation of the present invention provides a liquid composition comprising water and one or more ingredients selected from the group consisting of D-glucuronolactone, milk thistle extract, prickly pear extract, acai extract, and zeolites. Such a liquid composition can be regarded, for instance, as an “enhanced water” drink. The water is preferably spring water or purified water, such as purified by distillation, nanofiltration, reverse-osmosis, or some other means of separation and purification. The enhanced water can be carbonated and/or pH-adjusted, if desired. In one particular embodiment, a liquid composition includes water and zeolites.

D-glucuronolactone is a water-soluble crystalline compound found in plant gums, as polymers with other carbohydrates. D-glucuronolactone is also known as Glucuronolactone or Glucuronic acid lactone. Without being limited to any hypothesis, D-glucuronolactone can help fight fatigue and provide a sense of well-being. According to “The Merck Index” (14th edition), D-glucuronolactone also can act as a detoxicant.

Milk thistle extract is derived from milk thistles, which are thistles of the genus Silybum Adans. Without being limited to any hypothesis, milk thistle is believed to have protective effects on the liver and to improve its function. Milk thistle extract comprises silymarin, a mixture of at least four closely related flavonolignans, most of which is a mixture of two diastereomers of silybin.

Prickly pear extract is derived from Opuntia ficus-indica (Indian Fig Opuntia), a species of cactus. Most culinary references to the “prickly pear” are referring to this species. Without being held to any theory, Indian Fig Opuntia may reduce the negative effects of alcohol hangover by inhibiting the production of inflammatory mediators in humans.

Acai extract is derived from the acai palm, a member of the genus Euterpe, which contains seven species of palms native to tropical Central and South America. Without being held to any theory, acia extract is thought to provide, inter alia, antioxidant properties while contributing beneficially to beverage taste.

Zeolites are, generally speaking, aluminosilicate minerals with a microporous structure having pore diameters typically smaller than about 10 nm. Aluminosilicates (or silicoaluminates) are mineral compounds that contains aluminum, silicon, and oxygen atoms. As examples, andalusite, kyanite, and sillimanite are naturally occurring aluminosilicate minerals that have the composition Al₂SiO₅. Zeolites are typically formed as porous structures comprising hydrated aluminosilicate minerals.

Zeolites useful for this invention can be natural or synthetic zeolites. Cellular zeolite is a natural mineral that can be found in volcanic ash. In a process known as devitrification, the mineral is formed over millions of years when lava remains in contact with fresh or salt water. Synthetic zeolites can be generated by a process of slow crystallization of a silica-alumina gel in the presence of alkalis and organic templates. One of the important processes used to carry out zeolite synthesis is sol-gel processing. The product properties depend on reaction mixture composition, pH of the system, operating temperature, reaction time, as well as the templates used.

Zeolites possess a crystalline structure and honeycomb framework of cavities and channels that are capable of trapping toxins and heavy metals. In embodiments of the invention wherein zeolites are included in a recovery blend, the zeolites can remove toxins from the human body in just several hours. Without being held to any theory, this function of zeolites can enhance mental and physical performance and endurance, in addition to accelerating recovery from stresses.

Some embodiments of the invention provide several nutrients or vitamins that are known to be beneficial to humans. For example, in various embodiments, some or all of the following nutrients or vitamins are included: sodium, potassium, riboflavin, niacin, vitamin B6, vitamin B12, pantothernic acid, vitamin C, magnesium, calcium, and inositol.

Caffeine can be included in some variations of the invention. Caffeine is a known stimulant that can increase bio-available energy and enhance metabolism. Caffeine activates dopamine-like substances in the brain, promoting a general sense of well-being for a consumer. Without being limited by any particular theory, caffeine is believed to shuttle certain other ingredients directly to the blood stream.

Any source of caffeine can be used. Some embodiments utilize a natural source, such as coffee beans. Various amounts of caffeine can be employed, such as about 10-200 mg, preferably about 50-125 mg, and more preferably about 75-100 mg caffeine per 8 fluid ounces of total liquid.

Many natural or artificial flavors are possible, as will be appreciated. Natural flavors are preferred, but that is not necessary for the present invention. Also, various natural and artificial colors may be used, depending on the desired color of the product.

When natural sweetening is desired, the type and source of sugar can vary. The sweetener can comprise one or more sugar molecules selected from the group consisting of glucose, sucrose, and fructose. In some preferred embodiments, at least some of the sugar is derived from granulated sugar, such as beet sugar or cane sugar which has been processed and allowed to crystallize. In other embodiments, at least some of the sugar is derived from high-fructose corn syrup.

When it is desired to reduce calorie (carbohydrate) content, one or more non-sugar sweeteners can be introduced. Artificial sweeteners can be selected from any known possibilities, such as (but not limited to) acesulfame-K, sucralose, aspartame, and saccharin. Natural low-calorie sweeteners can optionally be used, i.e. sweeteners that are from natural sources and that are not substantially digested by humans. One example of a natural low-calorie sweetener is stevia, which comes from a shrub native to Paraguay.

In some embodiments, some amount of sugar (glucose, sucrose, and/or fructose) is used along with one or more low-calorie sweeteners. This can be beneficial for reasons of taste as well as the provision of caloric energy in the sugar.

In some embodiments, a liquid composition comprises one or more ingredients selected from the group consisting of D-glucuronolactone, milk thistle extract, prickly pear extract, acai extract, and zeolites; and carbonated water, acesulfame-K and/or sucralose, citric acid, cellulose gum, sodium chroride, potassium phosphate, caffeine, ascorbic acid, potassium sorbate, niacin, calcium lactate gluconate, trimagnesium citrate, D-calcium panthothenate, pyridoxine, riboflavin, cyanocobalamin, and one or more natural or artificial flavors. Taurine is preferably not included.

Yet another variation of the invention provides liquid compositions that can be used as cocktail mixers with any type of alcohol. As used herein, “alcohol” means a beverage containing ethanol—e.g., vodka, whiskey, wine, beer, etc. In these embodiments, the liquid composition comprises one or more ingredients selected from the group consisting of D-glucuronolactone, milk thistle extract, prickly pear extract, acai extract, and zeolites; and carbonated water, sugar, citric acid, cellulose gum, sodium chroride, potassium phosphate, caffeine, ascorbic acid, potassium sorbate, niacin, calcium lactate gluconate, trimagnesium citrate, D-calcium panthothenate, pyridoxine, riboflavin, cyanocobalamin, and one or more natural or artificial flavors. Taurine is preferably not included.

Amounts or concentrations of D-glucuronolactone, milk thistle extract, prickly pear extract, acai extract, or zeolites can vary. The amount or concentration of any specific ingredient within a recovery blend can be adjusted for functional reasons, for taste reasons, for economic reasons, or for other reasons. Similarly, amounts or concentrations of water, sweeteners, acids, salts, caffeine, minerals, vitamins, and flavors can be adjusted for many reasons.

Various methods known in the art can be employed to combine the selected ingredients in a manner suitable for a consumer beverage, such as an energy drink. The particular manner of mixing is not regarded as critical to the invention, as will be recognized by a person having ordinary skill in the art. Generally, the manufacture of liquid or solid products according to the invention will be carried out in a manner that provides an economical process.

For liquids, it is preferable to start with water that has been effectively purified, such as by distillation, nanofiltration, reverse-osmosis, or some other means of separation and purification.

It can be preferable, but not necessary, to blend ingredients using a methodology based on the equilibrium solubilities of the components into the evolving mixture. In some embodiments, each ingredient is substantially dissolved into the mixture prior to addition of the next ingredient. In other embodiments, certain combinations of several ingredients are added simultaneously and allowed to dissolve or mix.

Many different orders of steps are possible, but practical considerations can dictate that certain ingredients be introduced sooner or later in an overall procedure (e.g., carbonation is preferably conducted just prior to filling into containers).

For reasons of convenience, or economics related to ingredient supply or cost, some of the ingredients can be added in functionally equivalent forms (hydrates, salts, acids, bases, etc.). For example, pyridoxine can be added as pyridoxine HCl, aluminosilicate can be introduced in the form of sodium aluminosilicate, and so on.

Various means of quality control can be implemented, such as taste, color, pH, CO₂ content, and brix (a measurement of the dissolved sugar-to-water mass ratio). Other measures of quality control can include density, viscosity, temperature stability, ingredient precipitation, and so on.

Liquid compositions provided herein can further be filled into containers, such as cans, bottles, drums, liquid-packs, or other commercial containers. Certain preferred embodiments utilize aluminum cans that can be distributed, marketed, and sold to consumers directly.

In this detailed description, reference has been made to multiple embodiments in which is shown by way of illustration specific exemplary embodiments in which the invention may be practiced. These embodiments are described in sufficient detail to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the invention. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein.

The embodiments, variations, and figures described above should provide an indication of the utility and versatility of the present invention. Of course, many more devices can be developed that involve combinations of device elements as provided herein. Other embodiments that do not provide all of the features and advantages set forth herein may also be utilized, without departing from the spirit and scope of the present invention. Such modifications and variations are considered to be within the scope of the invention defined by the appended claims.

What is claimed is:

1. A liquid beverage comprising a recovery blend including zeolites.

2. The liquid beverage of claim 1, wherein said recovery blend further includes one or more materials selected from the group consisting of D-glucuronolactone, milk thistle extract, prickly pear extract, and acai extract.

3. The liquid beverage of claim 2, wherein said recovery blend includes two or more materials selected from the group consisting of D-glucuronolactone, milk thistle extract, prickly pear extract, and acai extract.

4. The liquid beverage of claim 3, wherein said recovery blend includes three or more materials selected from the group consisting of D-glucuronolactone, milk thistle extract, prickly pear extract, and acai extract.

5. The liquid beverage of claim 4, wherein said recovery blend includes D-glucuronolactone, milk thistle extract, prickly pear extract, and acai extract.

6. The liquid beverage of claim 1, wherein said zeolites are cellular zeolites.

7. The liquid beverage of claim 1, wherein said zeolites are synthetic zeolites.

8. The liquid beverage of claim 1, wherein said beverage does not include taurine.

9. The liquid beverage of claim 1, wherein said beverage is a naturally sweetened energy drink.

10. The liquid beverage of claim 1, wherein said beverage is an artificially sweetened energy drink.

11. The liquid beverage of claim 1, wherein said beverage is a water drink.

12. A liquid beverage comprising a recovery blend including milk thistle extract and prickly pear extract.

13. The liquid beverage of claim 12, wherein said beverage is an energy drink.

14. The liquid beverage of claim 12, wherein said recovery blend further includes zeolites.

15. A recovery blend comprising milk thistle extract and prickly pear extract.

16. The recovery blend of claim 15, further comprising zeolites.

17. The recovery blend of claim 15, further comprising acai extract.

18. The recovery blend of claim 15, further comprising D-glucuronolactone.

19. The recovery blend of claim 16, further comprising acai extract.

20. The recovery blend of claim 19, further comprising D-glucuronolactone.
